(19) United States
(12) Patent Application Publication
(10) Pub. No.: US 2014/0216398 A1
(43) Pub. Date: Aug. 7, 2014

(54) TURBOCHARGER OPERATION TO INCREASE BRAKE EFFECTIVENESS

(71) Applicants: Luis Carlos Cattani, Aurora, IL (US); John Zagone, Westmont, IL (US); Bashar Y. Melhem, Orland Park, IL (US); Paul Gottemoller, Palos Park, IL (US); Michael D. Bartkowicz, Oswego, IL (US)

(72) Inventors: Luis Carlos Cattani, Aurora, IL (US); John Zagone, Westmont, IL (US); Bashar Y. Melhem, Orland Park, IL (US); Paul Gottemoller, Palos Park, IL (US); Michael D. Bartkowicz, Oswego, IL (US)

(73) Assignee: International Engine Intellectual Property Company LLC, Lisle, IL (US)

(21) Appl. No.: 14/240,606

(22) PCT Filed: Aug. 25, 2011
(86) PCT No.: PCT/US11/49035

§ 371 Date: Feb. 24, 2014

(51) Int. Cl. F02B 37/12

(52) U.S. Cl. CPC F02B 37/12
USPC 123/320

(57) ABSTRACT

In response to activation of a compression release brake when a motor vehicle having a turbocharged internal combustion engine is operating at some elevation above sea level and a turbocharger compressor is operating in a region of an operating map which is creating boost air in an engine intake manifold which would cause the compression release brake to decelerate the vehicle more slowly at that elevation than it would at sea level for the same operating conditions of the vehicle and engine other than altitude, the compression release brake decelerates the vehicle less slowly by operating a valve mechanism to reduce flow through a charge air cooler and increase flow through a charge air cooler by-pass.

### TECHNICAL FIELD

This disclosure relates to a motor vehicle, such as a large truck vehicle, which is propelled by a turbocharged (either single- or multiple-stage) internal combustion propulsion engine having a compression release brake.

### BACKGROUND

Some internal combustion propulsion engines, such as diesel engines which typically run unthrottled, have a compression release braking mechanism, sometimes simply called a compression release brake. A compression release brake functions to release air which reciprocating pistons have compressed within the engine cylinders during compression upstrokes of the pistons into an exhaust manifold of the engine so that energy used to compress the air is not recovered and used as a contribution to propulsion of the vehicle during ensuing downstrokes of the pistons.

When a motor vehicle is in motion after having been accelerated by its propulsion engine, and a driver of the vehicle ceases operating an accelerator control for the propulsion engine while road-engaging drive wheels of the vehicle continue to be coupled to the propulsion engine through a drivetrain, the propulsion engine begins to be driven by the road-engaging drive wheels through the drivetrain, rather than by combustion of fuel in the engine cylinders, and as a result the load imposed on the drive wheels by the drivetrain and engine begins to decelerate the vehicle. If the engine has a compression release brake, the latter can be activated by the driver's operation of a compression release brake control to decelerate the vehicle more quickly than if the compression release brake is not activated. An example of such a control comprises an on-off switch for activating and de-activating the compression release brake and possibly a selector switch for selecting which engine cylinders will be used for engine braking. A control may also provide for engine braking to occur automatically upon the driver releasing the accelerator.

In an unthrottled turbocharged propulsion engine, air from an intake manifold enters through an open cylinder intake valve or valves of a respective engine cylinder into the engine cylinder during an intake downstroke of a piston which reciprocates within the engine cylinder and is coupled by a connecting rod to a crankshaft of the engine. The mass airflow into the respective engine cylinder is a function of pressure in the intake manifold which is created by a compressor (single- or multi-stage) of a turbocharger, i.e. is a function of boost created by a turbocharger compressor.

As the engine cycle for each engine cylinder transitions from an intake downstroke to a compression upstroke, the respective cylinder intake valve or valves operate from open to closed. Because one or more cylinder exhaust valves for each engine cylinder remain closed during the respective piston's compression upstroke, intake valve closing causes a volume of air which has entered a respective engine cylinder during the piston downstroke to be trapped in the respective engine cylinder. As the respective piston upstrokes, it compresses the trapped volume of air. Kinetic energy of the moving vehicle provides the energy to compress the trapped air, thereby contributing to vehicle deceleration.

In the absence of compression release braking, intake and exhaust valves for the respective engine cylinder would remain closed for substantially most of an ensuing downstroke of the respective piston after a compression upstroke, thereby allowing the energy of expansion of the trapped air to force the respective piston downward and return energy through the drivetrain as a contribution to vehicle acceleration.

Activation of a compression release brake opens a respective engine cylinder to an exhaust manifold slightly in advance and/or during at least some portion of what would otherwise be an expansion power downstroke of the respective piston if combustion were occurring in the engine cylinder. Activation of the compression release brake causes energy imparted to air which was compressed during a compression upstroke to be dissipated to the exhaust manifold instead of being recovered and used to contribute to vehicle acceleration.

The purpose of activating a compression release engine brake is therefore to essentially eliminate contributions to vehicle acceleration which would otherwise occur during an expansion downstroke if air whose compression has contributed to vehicle deceleration during a compression upstroke were allowed to expand within the engine cylinder during the downstroke.

When travelling on roadways through mountainous regions, a vehicle may have no alternative but to operate at elevations significantly above sea level. The geography of such regions may compel roadway design to comprise significant grades along which a vehicle is likely to encounter both upgrades and downgrades. Equipping the propulsion engine of such a vehicle with a turbocharger enables the engine to develop increased torque and power useful for upgrade travel. Equipping the propulsion engine with a compression release brake enables the propulsion engine to decelerate the vehicle during downgrade travel either by itself or in conjunction with use of vehicle service brakes.

### SUMMARY

It has been discovered that when a compression release brake is activated while a vehicle is operating at some elevation above sea level with the turbocharger compressor operating in a region of an operating map which would cause the compression release brake to decelerate the vehicle more slowly at that elevation than it would at sea level for the same operating conditions of the vehicle and engine other than altitude, and with a charge air cooler removing at least some heat of compression from air compressed by the turbocharger compressor, the compression release brake can decelerate the vehicle more quickly at the higher elevation by reducing flow through the charge air cooler and increasing flow through a charge air by-pass which parallels the charge air cooler. The increased thermal energy in flow entering the intake manifold enables the turbocharger to increase compressor efficiency and hence more quickly increase boost.

One general aspect of the claimed subject matter relates to the method defined by independent Claim 1.

Another general aspect of the claimed subject matter relates to the vehicle defined by independent Claim 3.

The foregoing summary is accompanied by further detail of the disclosure presented in the Detailed Description below with reference to the following drawings which are part of the disclosure.

### BRIEF DESCRIPTION OF THE DRAWINGS

FIG. 1 schematically shows a truck vehicle having a turbocharged internal combustion propulsion engine which has a compression release brake.

FIG. 2 is a general schematic diagram of the propulsion engine.

FIGS. 3A, 3B, 3C, and 3D comprise a series of time-based graph plots of certain turbocharger and engine operating parameters during downgrade travel of a vehicle.

FIG. 4 is a compressor operating efficiency diagram for the turbocharger with data points correlated with FIG. 3.

FIG. 5 is a diagram showing graph plots of engine braking effort as a function of boost.

FIG. 6 is a compressor efficiency diagram.

### DETAILED DESCRIPTION

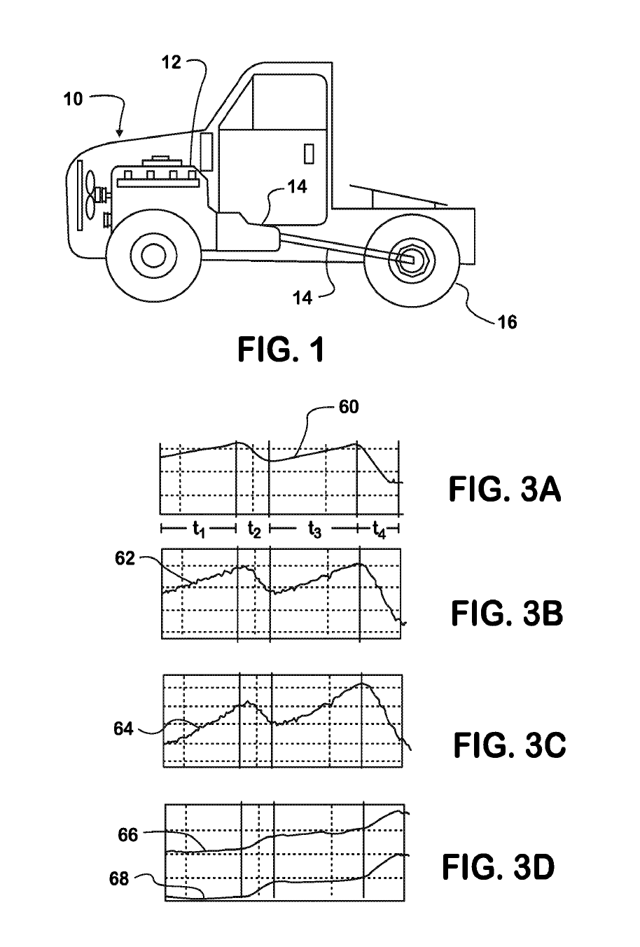

FIG. 1 shows a truck vehicle 10 which is propelled by a multi-cylinder internal combustion propulsion engine 12 operating to deliver torque through a drivetrain 14 to drive wheels 16.

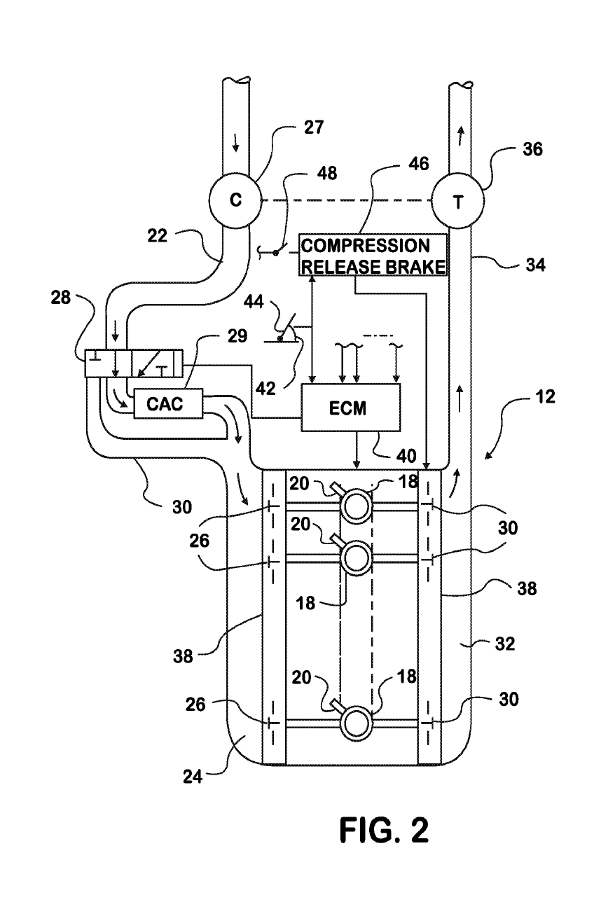

FIG. 2 shows multi-cylinder internal combustion propulsion engine 12 as a diesel engine which comprises structure forming a number of engine cylinders 18 into which fuel is injected by fuel injectors 20 to combust with air which has entered engine cylinders 18 through an intake system 22. Engine 12 comprises an intake manifold 24 through which air which has passed through intake system 22 enters engine cylinders 18 when cylinder intake valves 26 for controlling admission of air from intake manifold 24 into respective engine cylinders 18 are open.

Intake system 22 comprises a compressor 27 which may comprise either a single stage or multiple stages for elevating pressure in intake manifold 24 to superatmospheric pressure, meaning pressure greater than that of ambient air pressure, i.e. for creating boost in intake manifold 24. Intake system 22 also comprises a valve mechanism 28, a charge air cooler (CAC) 29, and a charge air cooler by-pass (CAC by-pass) 30. Other components which may be present in intake systems of contemporary diesel engines are not shown. CAC 29 is a heat exchanger (such as an air-to-air heat exchanger) which is used to remove some of the heat of compression imparted to charge air by compressor 27, thereby reducing the temperature of air entering intake manifold 24 and subsequently engine cylinders 18.

CAC 29 and CAC by-pass 30 are arranged in parallel flow paths to intake manifold 24. Valve mechanism 28 controls how much of the flow coming from compressor 27 passes through CAC 29 and how much by-passes CAC 29 to instead pass through CAC by-pass 30. The schematically illustrated arrangement of valve mechanism 28, CAC 29, and CAC by-pass 30 is intended to be merely representative of a number of possible implementations for controlling flow into intake manifold 24.

FIG. 2 shows valve mechanism 28 in a first operating condition which causes all of the flow from compressor 27 to pass through CAC 29 and none to pass through CAC by-pass 30. This causes some of the heat of compression in the flow to be removed before the flow enters intake manifold 24.

Valve mechanism 28 is also operable to a second operating condition which causes all of the flow from compressor 27 to pass through CAC by-pass 30 and none to pass through CAC 29. Heat of compression which would otherwise be removed from the flow by CAC 29 is therefore not removed, raising the thermal energy of flow entering intake manifold 24 from that which the flow would have with valve mechanism 28 in the first operating condition.

Engine 12 further comprises cylinder exhaust valves 31 for controlling admission of exhaust from respective engine cylinders 18 into an exhaust manifold 32 for further conveyance through an exhaust system 34. Exhaust system 34 includes a turbine 36 which may comprise either a single stage or multiple stages each of which is coupled by a respective shaft to operate a respective stage of compressor 27. Other components which may be present in exhaust systems of contemporary diesel engines are not shown.

Collectively, compressor 27 and turbine 36 form a turbocharger which may be either a single- or a multiple-stage type.

Engine 12 comprises mechanisms 38 for controlling the timing of opening and/or closing of cylinder intake valves 26 and cylinder exhaust valves 31 respectively during engine cycles. The mechanisms may comprise one or more camshafts (depending on engine configuration) having cams shaped to provide fixed timing of operation of the cylinder valves. If an engine has variable valve actuation (VVA) for varying timing of opening and/or closing of cylinder valves, that capability may be provided by any of a variety of mechanisms.

A processor-based engine control module (ECM) 40 controls various aspects of engine operation, such as fueling of engine cylinders 18 by fuel injectors 20. Control is accomplished by processing various input data, including accelerator position data from an accelerator position sensor 42 operated by an accelerator 44, shown schematically as a foot pedal which is depressed by a driver of the vehicle to accelerate propulsion engine 12.

Engine 12 also has a compression release brake 46 which, when activated, interacts with cylinder exhaust valves 31 in a manner which causes them to open during portions of engine cycles which are significantly different from portions of engine cycles during which they would otherwise be open if truck vehicle 10 were being propelled by combustion in engine cylinders 18. Activation and de-activation of compression release brake 46 may be controlled in any of various ways.

One type of control comprises an on-off switch 48 which can be operated by a driver of the vehicle to activate and de-activate compression release brake 46. A control may also include a selector switch (not shown) for selecting which engine cylinders 18 will be used for engine braking. A control may also provide for engine braking to occur automatically upon the driver releasing accelerator 44.

The operating condition of valve mechanism 28 is under the control of ECM 40.

When truck vehicle 10 is in motion, and its driver is operating accelerator 44, ECM 40 causes engine 12 to be fueled in accordance with a fueling strategy so that engine 12 delivers torque through drivetrain 14 to drive wheels 16 for propelling truck vehicle 10. When the driver ceases to operate accelerator 44 while drive wheels 16 continue to be coupled to propulsion engine 12 through drivetrain 14, propulsion engine 12 begins to be driven by drive wheels 16 through drivetrain 14, rather than by combustion of fuel in engine cylinders 18. Engine braking can then be initiated either automatically or by the driver operating switch 48 to ON position to activate compression release brake 46.

In response to activation of compression release brake 46 when truck vehicle 10 is operating at some elevation above sea level with valve mechanism 28 in the first operating condition which places CAC 29, and not CAC by-pass 30, in the flow path to intake manifold 24 and with compressor 27 operating in a region of an operating map which is creating boost in intake manifold 24 which would cause compression release brake 46 to decelerate truck vehicle 10 more slowly at that elevation than it would at sea level for the same operating conditions of the vehicle and propulsion engine other than altitude, ECM 40 operates valve mechanism 28 to the second operating condition which places CAC by-pass 30, and not CAC 29, in the flow path to intake manifold 24. Because the flow entering intake manifold 24 now ceases being cooled by CAC 29, the thermal energy of charge air entering intake manifold 24 is promptly increased and because of that increase, compression release brake 46 decelerates the vehicle less slowly than it would have if use of CAC 29 been continued.

ECM 40 can contain an algorithm representing a strategy for determining if CAC by-pass 30 should be used when use of compression release brake 46 is requested. The algorithm can process boost data and ambient atmospheric pressure data in making the determination.

FIGS. 3A, 3B, 3C, and 3D comprise contemporaneous traces showing certain operating parameters as a function of time during a downgrade test drive of a vehicle having a turbocharged propulsion engine. It is because of the discernment of relationships present in FIGS. 3A, 3B, 3C, and 3D, relationships which, it is believed, would be recondite to others, that the claimed subject matter has been developed.

FIG. 3A contains a trace 60 representing engine speed in non-dimensional units of measurement; FIG. 3B, a trace 62 representing speed of a high-pressure stage of a turbocharger compressor in non-dimensional units of measurement; FIG. 3C, a trace 64 representing speed of a low-pressure stage of the turbocharger compressor in non-dimensional units of measurement; and FIG. 3D, a trace 66 representing outlet pressure of the high-pressure stage of the turbocharger compressor in non-dimensional units of measurement and a trace 68 representing boost in an intake manifold of the propulsion engine in non-dimensional units of measurement.

During a span of time t1 which begins with the vehicle at a first altitude, traces 66 and 68 show that both outlet pressure of the high-pressure stage of the turbocharger compressor and boost remain largely unchanged even through traces 60, 62, and 64 show that engine and turbocharger speeds are increasing as the vehicle is descending toward a second altitude which is lower than the first. The outlet pressure of the high-pressure stage of the turbocharger compressor and boost are largely unchanged during this time because the turbocharger is causing the compressor to operate in a relatively less efficient region of an operating map.

During a span of time t2 which begins with the vehicle at the second altitude, traces 66 and 68 show that both engine speed and turbocharger speed have begun to decrease. However, both outlet pressure of the high-pressure stage of the turbocharger compressor and boost are beginning to increase. This is because the decreasing turbocharger speed is causing the compressor to operate in a relatively more efficient region of the operating map.

During a span of time t3 which begins with the vehicle having descended to a third altitude lower than the second altitude, traces 60, 62, and 64 show that engine speed and turbocharger speeds are once again increasing while traces 66 and 68 show that both outlet pressure of the high-pressure stage of the turbocharger compressor and boost are being maintained at levels as high as or slightly higher than levels during span of time t1.

When engine and turbocharger speeds again start to decrease at the beginning of a span of time t4 with the vehicle having descended to a fourth altitude lower than the third altitude, their continued decrease causes both outlet pressure of the high-pressure stage of the turbocharger compressor and boost to increase even more rapidly than they did during span of time t2.

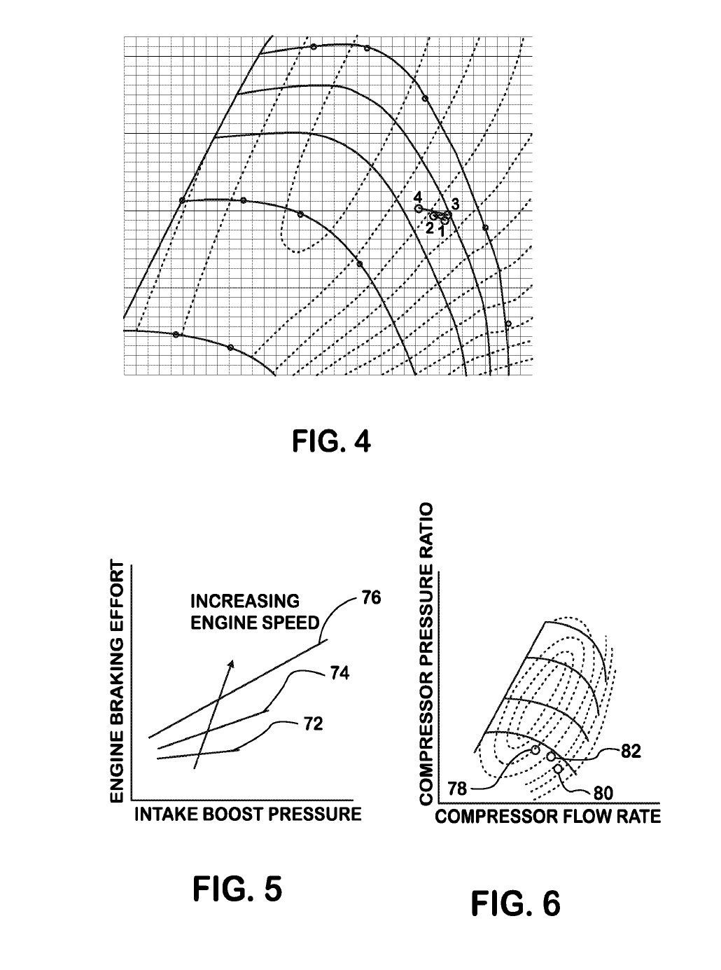

Points 1, 2, 3, and 4 in FIG. 4 show an undimensioned map of compressor operating efficiency at the ends of spans of time t1, t2, t3, and t4 in FIGS. 3A, 3B, 3C, and 3D. It can be seen that between points 1 and 2 and between points 3 and 4, compressor operating efficiency has increased by movement toward islands of higher efficiency.

Because effectiveness of compression release brake 46 depends on boost, and because compression release brake 46 may be activated when compressor 27 is operating in a relatively less efficient region of an operating map, the capability of operating valve mechanism 28 to discontinue use of CAC 29, as described above, can enable compression release brake 46 to become more effective sooner than it otherwise would due to slowness of the compressor in increasing boost. By discontinuing use of CAC 29, additional thermal energy is promptly added to boost air for enabling the turbocharger to increase compressor efficiency and hence more quickly increase boost when compared to not discontinuing use of CAC 29. This improvement in engine braking is of significance to vehicles when traveling downgrade at elevations significantly above sea level.

FIG. 5 shows three representative plots 72, 74, 76 of engine braking effort as a function of boost at each of three successively higher engine speeds. They show that engine braking effort generally increases with increasing boost.

FIG. 6 shows three points 78, 80, and 82 on a compressor efficiency map. Point 78 represents compressor efficiency when the vehicle is operating at low altitude, and point 80 represents compressor efficiency when the vehicle is operating at high altitude. The lower efficiency represented by point 80 in comparison to the higher efficiency represented by point 78 is due to the turbocharger's inherent limitations. By not using charge air cooling at higher altitude, compressor efficiency is improved to point 82, enabling compression release brake 46 to become more effective sooner than it might otherwise at higher altitude.

Depending on a particular engine and a particular control strategy, it may be possible to integrate the use of a charge air cooler by-pass as described above with use of an intake manifold heater, as described in the commonly owned patent application of the inventors (Attorney Docket D7004) incorporated herein by reference, to accomplish improved effectiveness of a compression relief brake at higher altitudes.

What is claimed is:

1. In a motor vehicle comprising:
an internal combustion propulsion engine coupled to road-engaging drive wheels through a drivetrain;
the propulsion engine comprising engine cylinders within which pistons are reciprocated to propel the vehicle by delivering torque through the drivetrain to the road-engaging drive wheels when fuel is combusted within the engine cylinders, but when fuel is not being combusted within the engine cylinders and the vehicle is rolling on a road surface underlying the drive wheels, the pistons are reciprocated by the road-engaging wheels acting through the drivetrain;
the propulsion engine further comprising an intake system, an exhaust system, an intake manifold through which air which has passed through the intake system enters the engine cylinders to support combustion, and an exhaust manifold through which exhaust resulting from combustion leaves the engine cylinders for ensuing passage through the exhaust system;
a turbocharger comprising a turbine in the exhaust system operated by exhaust from the exhaust manifold and a compressor in the intake system operated by the turbine for creating pressure in the intake manifold exceeding ambient atmospheric pressure;
the intake system comprising a charge air cooler and a charge air cooler by-pass arranged in parallel flow paths to the intake manifold, and a valve mechanism for controlling flows through the parallel flow paths; and
a compression release brake which, when the pistons are being reciprocated by the road-engaging wheels acting through the drivetrain, rather than by in-cylinder combustion, can be activated to dissipate energy of air which a respective piston has compressed within at least one engine cylinder by causing air which the respective piston has compressed to be released into the exhaust manifold so that energy of the released air is not recovered as a contribution to propulsion of the vehicle,
a method comprising:
in response to activation of the compression release brake when the vehicle is operating at some elevation above sea level, when the valve mechanism is controlling flows through the parallel flow paths to cause at least some charge air entering the intake manifold to have passed through the charge air cooler, and when the compressor is operating in a region of an operating map which is creating boost in the intake manifold which would cause the compression release brake to decelerate the vehicle more slowly at that elevation than it would at sea level for the same operating conditions of the vehicle and propulsion engine other than altitude, causing the compression release brake to decelerate the vehicle less slowly by operating the valve mechanism to reduce flow through the charge air cooler and increase flow through the charge air cooler by-pass.

2. The method set forth in claim 1 in which the step of causing the compression release brake to decelerate the vehicle less slowly by operating the valve mechanism to reduce flow through the charge air cooler and increase flow through the charge air cooler by-pass comprises closing the charge air cooler to flow.

3. A motor vehicle comprising:
an internal combustion propulsion engine coupled to road-engaging drive wheels through a drivetrain for propelling the vehicle;
the propulsion engine comprising engine cylinders within which pistons are reciprocated to propel the vehicle by delivering torque through the drivetrain to the road-engaging drive wheels when fuel is combusted within the engine cylinders, but when fuel is not being combusted within the engine cylinders and the vehicle is rolling on a road surface underlying the drive wheels, the pistons are reciprocated by the road-engaging wheels acting through the drivetrain;
the propulsion engine further comprising an intake system, an exhaust system, an intake manifold through which air which has passed through the intake system enters the engine cylinders to support combustion, and an exhaust manifold through which exhaust resulting from combustion leaves the engine cylinders for ensuing passage through the exhaust system;
a turbocharger comprising a turbine in the exhaust system operated by exhaust from the exhaust manifold and a compressor in the intake system operated by the turbine for creating pressure in the intake manifold exceeding ambient atmospheric pressure;
the intake system comprising a charge air cooler and a charge air cooler by-pass arranged in parallel flow paths to the intake manifold, and a valve mechanism for controlling flows through the parallel flow paths;
a compression release brake which, when the pistons are being reciprocated by the road-engaging wheels acting through the drivetrain, rather than by in-cylinder combustion, can be activated to dissipate energy of air which the respective piston has compressed within at least one engine cylinder by causing air which the respective piston has compressed to be released into the exhaust manifold so that energy of the released air is not recovered as a contribution to propulsion of the vehicle;
and a control which, in response to activation of the compression release brake when the vehicle is operating at some elevation above sea level and the compressor is operating in a region of an operating map which is creating boost in the intake manifold which would cause the compression release brake to decelerate the vehicle more slowly at that elevation than it would at sea level for the same operating conditions of the vehicle and propulsion engine other than altitude, causes the compression release brake to decelerate the vehicle less slowly by operating the valve mechanism to reduce flow through the charge air cooler and increase flow through the charge air cooler by-pass.

4. The motor vehicle set forth in claim 3 in which the control causes the compression release brake to decelerate the vehicle less slowly by closing the charge air cooler to flow.
